(19) United States
(12) Patent Application Publication
(10) Pub. No.: US 2010/0023379 A1
(43) Pub. Date: Jan. 28, 2010

(54) Method and system for determining real estate market value changes

(75) Inventors: Edgar Rappaport, Montclair, NJ (US); Christopher C. Potter, Holmdel, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: HMVP Partners, LLC, New York, NY (US)

(21) Appl. No.: 12/459,865

(22) Filed: Jul. 7, 2009

Related U.S. Application Data
(60) Provisional application No. 61/134,199, filed on Jul. 7, 2008.

(51) Int. Cl. G06Q 40/00; G06Q 50/00; G06Q 10/00; G06F 17/30

(52) U.S. Cl. 705/10; 705/400; 705/35; 707/104.1; 707/3; 707/102; 707/E17.018; 707/E17.014; 707/E17.044

(57) ABSTRACT

A method and system for valuing real estate property values comprises correlating sales price of benchmark properties of a predetermined size and determining the property value based on the correlation. In one aspect the benchmark properties are determined based on a preselected geographic area, which may include a postal or zip code which includes properties having sizes within a particular range of the predetermined size.

### CROSS-REFERENCE TO RELATED APPLICATIONS

This application claims the benefit of the filing date of U.S. Provisional Application No. 61/134,199, filed Jul. 7, 2008, the disclosure of which is incorporated herein by reference.

### BACKGROUND

The present invention generally relates to methods, apparatus and systems that are used to value real estate, and in particular to such methods, apparatus and systems that calculate the value of real estate based only on a single attribute associated with the property or a minimal set of same.

Economic slowdowns typically turn on the ability and willingness of consumers to complete purchase transactions. That ability and willingness includes both tangible and intangible components, which in turn generally depend on each other. One intangible component is generally referred to as consumer confidence. In general, the more confident consumers feel about the economy and their jobs and incomes, the more likely they are to make purchases. Although not included in the U.S. consumer confidence board survey, the housing market typically serves as a measure or monitor of consumer confidence. In particular, as consumer confidence wanes, fewer consumers are willing to take the leap into the housing market, and vice versa. An additional related factor in this interplay is tightness of credit markets, which have an effect on market liquidity (i.e., the ability to sell). All in all, the interplay between these factors is a complex dynamic that various players (e.g., economists, investors, governments) try to use to predict the current and future health of economies.

The complexity of that dynamic has been evident in a housing crisis where, as consumer confidence wanes, there are fewer entrants into the housing market leaving a glut of supply. The increasing supply glut coupled with tightness in the credit markets plays an important, if not decisive, role in the slowdown of home sales. Regardless of the measures taken by the U.S. government, in the short term, consumer confidence may not be and/or is not easily restored. Consumers thus become unwilling entrants into the housing market in the belief that the housing market has not yet bottomed out. Put another way, new entrants are concerned that home values will continue to decline in the future. At a macro level, home price values can reduce the value of businesses, and in some instances, drive those businesses into bankruptcy. In addition, among those businesses, lending institutions are generally unable to provide reliable predictions of the value of their assets vis-à-vis the housing market. In particular, the traditional methods of estimating home values are proving unreliable. In turn, this hinders the ability of these institutions to predict their current and potential future economic health.

Of utility, then, are methods and systems that allow for estimating real estate values.

### SUMMARY

As is shown in the accompanying drawings and explained in further detail below, there are many aspects to the present invention. For example, an aspect of the present invention is a method of establishing a unique value of an item of real estate that serves as a point of reference or benchmark. Such a benchmark may be used to value transactions involving real estate or by institutions (e.g., mortgaging companies, governments) as a measure of real estate market values.

In another aspect the present invention is a method for valuing real estate. The method comprises associating a geographic area with a property having a predetermined size metric; correlating one or more sales prices associated with benchmark properties, each benchmark property having a size metric within a range associated with the predetermined size metric of the property and selected based on the geographic area; and determining a first value associated with the property based on the correlation.

In accordance with this aspect of the present invention, the size metric of the property is specified for the interior floor space of a structure on the property. Further in accordance with this aspect of the present invention, the method further comprises determining a second value later in time associated with the property based on the correlation. In addition, determining a payout value may comprise computing a ratio associated with the difference between the first value and second value.

Further still in accordance with this aspect of the present invention, correlating comprises accessing a database having a plurality of postal codes, benchmark property values and size metrics, each benchmark property value being associated with a size metric, and processing the benchmark property values and size metrics to form a first group of property values within a predetermined statistical range. Furthermore, processing may further comprise accumulating 500 or more home sales prices associated with the benchmark properties based on the size metric to form the first group of property values.

Further in accordance with the method aspect of the present invention, determining a first value may comprise computing an average sale price associated with each benchmark property having a size metric within a range associated with the predetermined size metric of the property. Further still, correlating comprises correlating one or more sales prices associated with 100 or more benchmark properties. Even further, correlating may comprise associating the geographic area with a postal code or a zip code.

Further still, the sales prices are preferably between $100,000 and $1,000,000.

Further still in accordance with this aspect of the present invention, the structure may be a residence, and the residence may be a house. In addition, the size metric of the properties can be specified in acreage, square footage or meters.

In another aspect, the present invention may be an apparatus comprising a memory containing executable instructions; and a processor programmed using the instructions to: request a unique value associated with a specified residence, transmit a specified size value associated with the specified residence, and transmit a specified geographic area associated with the specified residence. In addition, the processor may also be programmed to receive the unique value, the unique value correlating to an average property price associated with one or more sales prices of benchmark residences, each benchmark residence having a size metric within a range associated with the predetermined specified residence size metric and selected based on a geographic area associated with the specified residence.

In accordance with this aspect of the present invention, the unique value may be a market value. Further in accordance with this aspect of the present invention, the residence may be a house. In addition, the residence size metric and benchmark residence size metrics are measured as interior floor space of the residences.

Further in accordance with this aspect of the present invention, the geographic area may comprise a postal code, zip code, a neighborhood or town. In addition, the processor may transmit an appraised value associated with the residence.

In another aspect, the present invention may also comprise an apparatus for computing a unique value associated with a residence comprising: a memory containing executable instructions; and a processor programmed using the instructions to: receive a request for a unique value associated with a residence, request a residence size value associated with the residence, and transmit the unique value, the unique value correlating to an average residence price associated with one or more sales prices associated with benchmark properties, each benchmark property having a residence size metric within a range associated with the predetermined residence size metric and selected based on a geographic area associated with the residence.

In accordance with this aspect of the present invention, the residence size metric and benchmark property residence size metrics are specified as the interior floor space of the residences. Furthermore, the residence may be a house. In addition, the geographic area is selected from a group consisting of a postal code, zip code, town, city, state or province.

In another aspect, the present invention is a system for determining home values. The system comprises a server; a database accessible by the server and having sales price data and property size data associated with a plurality of benchmark properties within a predetermined geographic area, each benchmark property being associated with at least one benchmark data set having a sales price and a property size; and a client device having a memory containing executable instructions and a processor programmed using the instructions to: access the server to request a first property value for a specified property; respond to a request from the server for a property size value associated with the specified property and a geographic area metric associated with the specified property, and receive the first property value associated with the specified property from the server, the first property value comprising an average sales price for all benchmarked marked properties having a property size within a predetermined size range and within the specified geographic area metric.

In yet another aspect, the present invention comprises an index for real estate valuation. The index comprises a plurality of recorded real estate sale prices within a geographic area metric; and a correlation of the recorded real estate prices with a predetermined size metric for the real estate within the geographic area metric, whereby the correlation provides a real estate valuation.

In a further aspect, the present invention is a market value mechanism for compensating home buyers for market devaluation. The mechanism comprises compiling an index of recorded home sales prices within a predetermined geographic metric; correlating the recorded home sales prices with the size of a home based on a predetermined property size metric to generate a market value index; and determining a first market value for a reference home having a predetermined size based on the sales price of a first set of recorded homes in the index within a size range of the predetermined sized. In accordance with this aspect of the present invention, the mechanism further comprises determining a second market value for the reference home based on the sales prices of a second set of recorded homes in the index within the size range of the predetermined property size metric.

### DESCRIPTION OF THE DRAWINGS

FIG. 1 illustratively depicts a method for determining real estate values in accordance with an aspect of the present invention.

FIG. 2 illustratively depicts a system that may be used in practicing the method aspect of the present invention.

FIG. 3 shows a flow chart of a method in accordance with a further aspect of the present invention.

FIGS. 4A and 4B illustrates an example of home valuation in accordance with an aspect of the present invention

### DESCRIPTION OF PREFERRED EMBODIMENTS

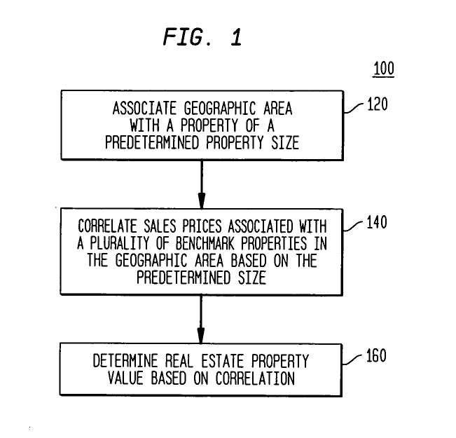

FIG. 1 illustratively depicts a method for determining real estate values in accordance with an aspect of the present invention. As shown in FIG. 1, the method 100 generally comprises three steps: step 120—associating a geographic area with a property of a predetermined size; step 140—correlating sales prices associated with properties of a particular size in the geographic area; and step 160—determining the property value based on, for example, the average sales price of property values found from the correlation.

Initially, at step 120, a geographic area is associated with a reference property. The geographic area may comprise, for example, an area covered by a postal or zip code. Alternatively, the geographic area may be identified based on any other known geographic or demographic boundaries, or any other suitable geographic area metric that defines a geographic region. In particular, in areas where there are no postal codes or zip codes, the geographic area may comprise a town or province or neighborhood. In addition to identifying a geographic area, step 120 also preferably includes the size of the property. Preferably, the property size metric is provided in square footage although other measurements of property size may be provided that are used to measure land size or interior floor space of a structure on a property such as a residence or home or, most particularly, a house. When the reference property is a home, the preferred size metric of the property is measured by its total interior floor space in terms of square footage or meters, or other quantitative metric. Where the reference property is a parcel of land, it may be measured in terms of size such as acreage or other suitable unit in a metric system. Regardless of how the property size is measured, e.g., square feet, meters, acreage, etc., each property within the geographic area is required to only have two datum of information: sales prices and property size. Each such sales price and size then becomes a benchmark value or data value that, as is explained in further detail below, can be used to calculate a unique value associated with a different property. The properties themselves are referred to as benchmark properties in this disclosure.

In a case where the properties in the geographic area are homes, the benchmark data, in contrast to other metrics used to value property, need not necessarily include a number of particular or often traditional characteristics of the properties. For example, the numbers of bedrooms, bathrooms, particular location of a home within the geographic area, etc., need not be included in the calculation. Accordingly, these characteristics have no bearing on the valuation calculation in contrast to other valuation methodologies that are used to value homes.

Using sales price and home size associations formed for a geographic area, the method then proceeds to step 160 where a correlation is made between the sales price of properties within a specified size range and the property for which valuation is sought. In particular, given a property of a predetermined size, benchmark properties within the geographic area of sizes within a selectable range of the predetermined size are retrieved. As such, a correlation is made between sales prices of homes sold within a geographic area and the size of the property for which valuation is sought.

A factor to the valuation process is the use of a significant statistical sample of benchmark properties to ensure that the valuation calculation is reliable. That is, consideration must be given to whether enough home sales within a particular size range have taken place to allow for a statistically significant sample of sales transactions to exist. For example, if the geographic area is comprised of homes within a particular zip code, enough home sales or transactions must have taken place within that zip code to form a reliable data set. In accordance with an aspect of the present invention, in choosing the geographic area or, as in this example, the zip code, a sample size of 100 to 300 transactions will likely form a statistically sound set for the valuation calculation. In this regard, for each 10,000 homes, this would require at least a 2% to 3% turnover in the time period used for calculation. Note however that more transactions will yield a more statistically sound calculation. For example, in accordance with another aspect of the present invention, the inventors have found that 500 or more home sales transactions provides a significant enough set of data that allows for improved statistical confidence.

Nevertheless, 2% is not a lower bound. For example, the size of the home for which valuation is sought may limit the number of available transactions. Homes with relatively large interior space, e.g., 10,000 square feet (929.03 square meters), may not turn over as often as homes with smaller interior space. Accordingly, in such circumstances the number of transactions may be less than 200 or amount to less than 2%. However, the present invention may be applied even under those conditions and is not limited in anyway by the number of available transactions. In addition, although the method is preferably applied to home sizes between 1,000 and 3,000 square feet, the present invention is not in anyway limited by home size.

In one aspect of the present invention statistical confidence may be achieved by varying the allowable size range (sample size range), the geographic area (sampling area) or the time period (sampling period) for the sales transactions that are used. With respect to the allowable size range, the size range may be initially selected to be within a few percentage points of the predetermined size. If a significant enough sample size cannot be established for correlation using a relatively small size range, then the size range may be increased by, for example, 10% or as much as needed to achieve a valid statistical sample set. Alternatively, the geographic area may be increased to include additional geographic areas until a valid statistical sample set is achieved. In general, statistical significance depends on a number of factors. Those factors include the relationship between number of homes in a geographic area and number of transactions, the distribution of prices around the mean price, and standard deviation. A statistically significant sample size can be determined by consideration of these factors and the sample size range, sampling area and sampling period.

In addition, the time period may be expanded to include more transactions. For example, in some areas 90 days may prove sufficient in forming a valid sample set. In other areas, a valid sample set may require one or more years. In any event, the three variables of time, area and size may be varied to achieve the desired sample set of sales transactions.

Another feature of the invention is that the method is preferably applied to homes grouped around a median price. For example, using current prices for a predetermined geographic area, the method is preferably applied to homes priced between $100,000 and $1,000,000. Depending on the geographic area subject to the present invention, it will be understood that the preferred price range will vary. The present invention is not, however, limited by home prices.

With the correlation made, the unique value of the property is then determined at step 160 based on the sales prices of similarly sized properties. The valuation may be calculated by, for example, averaging the sales price of all the homes in relevant sample data set, i.e., the sales prices selected based on home size. Other more sophisticated averaging methods may be used. For example, a weighted average that takes into account the deviation between home sizes, time over which the sales were made, or expansion to other geographic areas may be used. In this regard, the statistical significance of a sale made two years ago may be assigned a lower or higher weighting factor as compared to one that was made six months later or earlier, respectively. On the other hand, a weighing factor may be assigned to deviations between the predetermined size and the size of each property that forms the relevant data set.

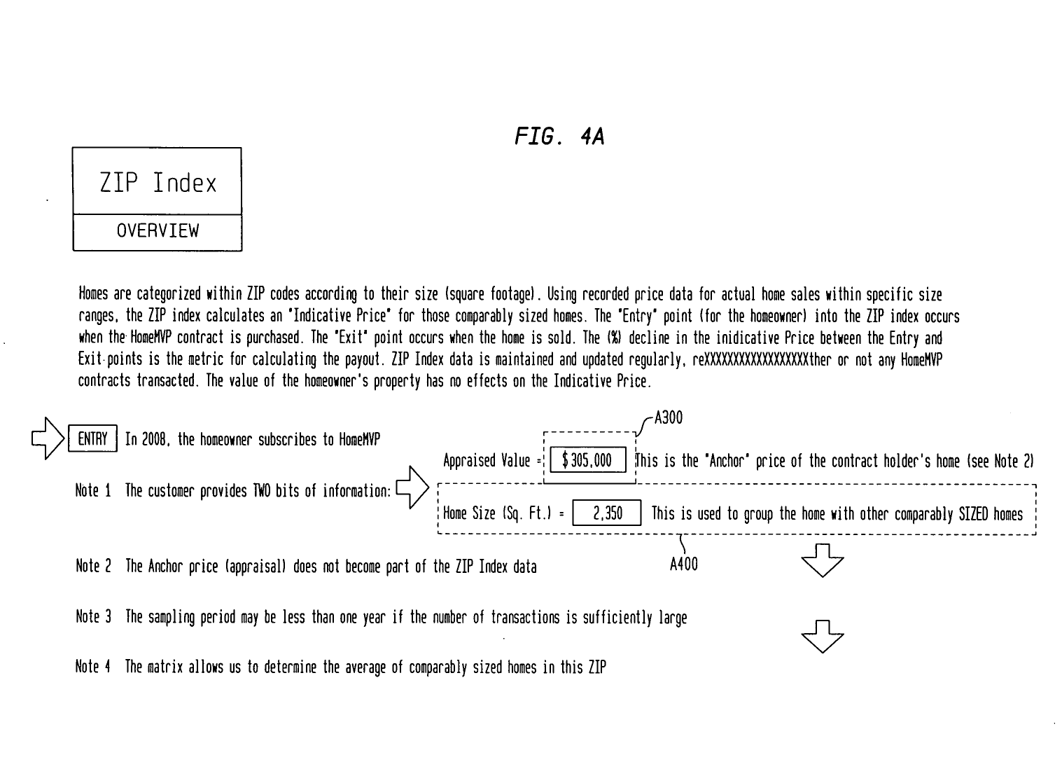

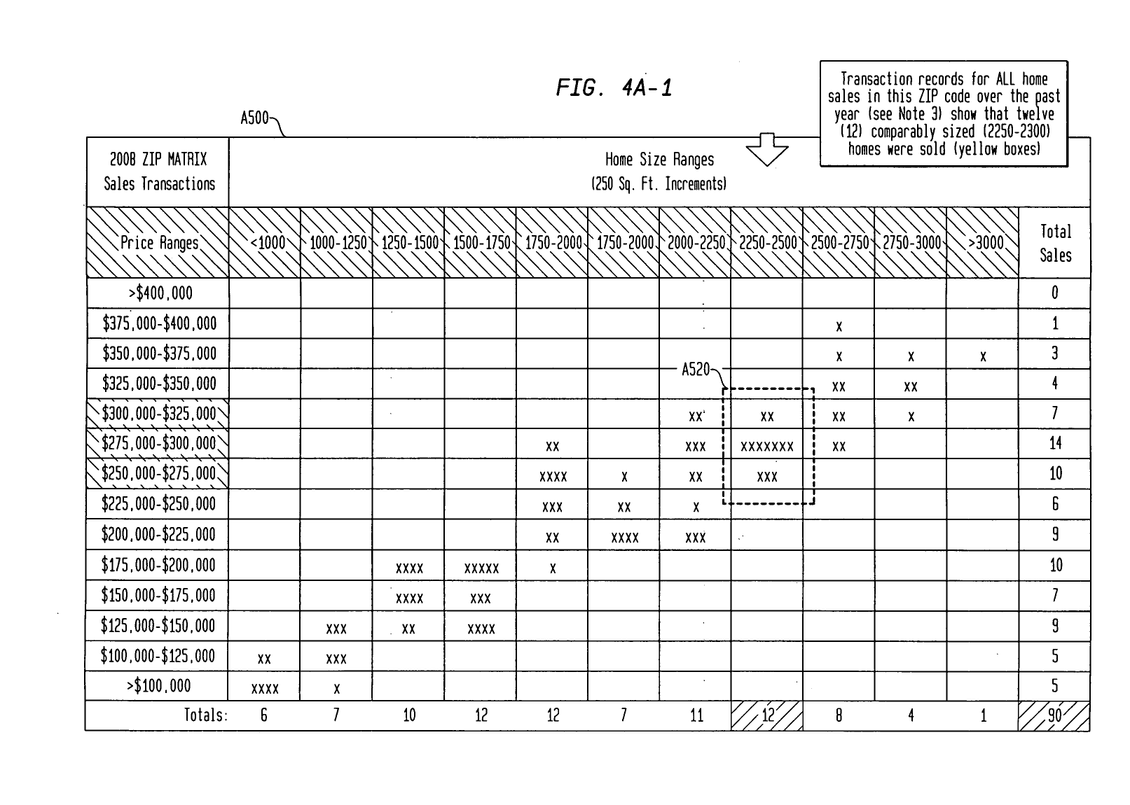

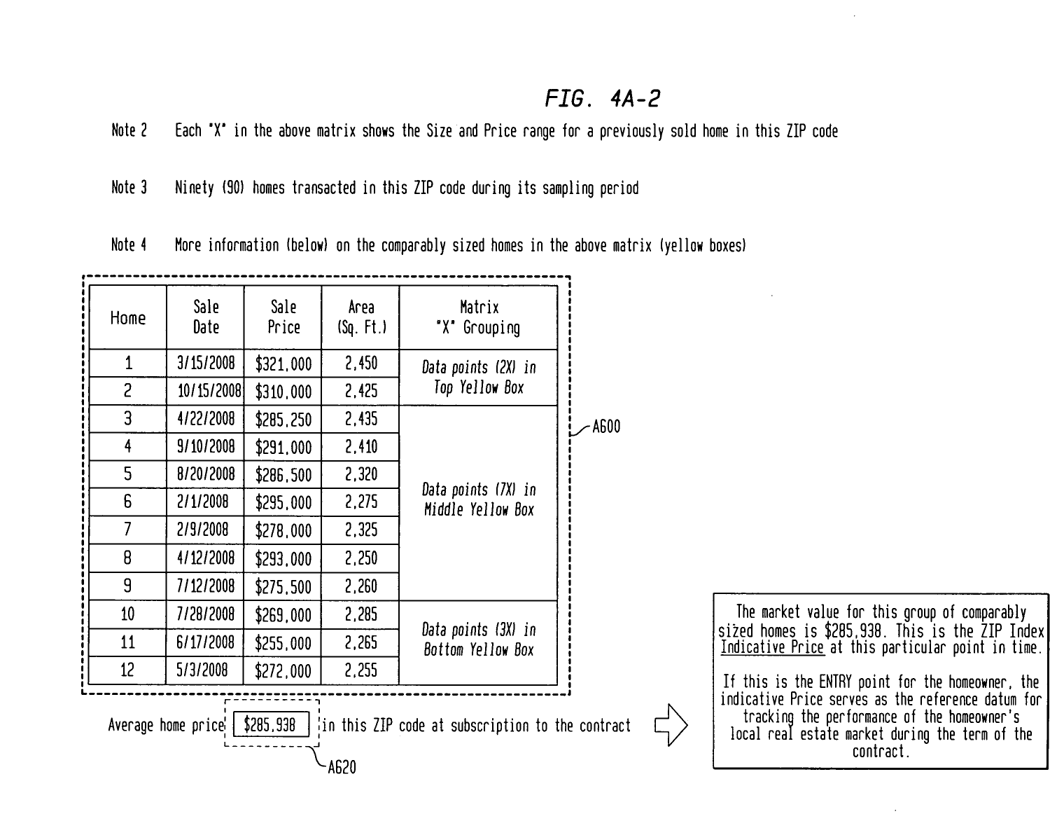

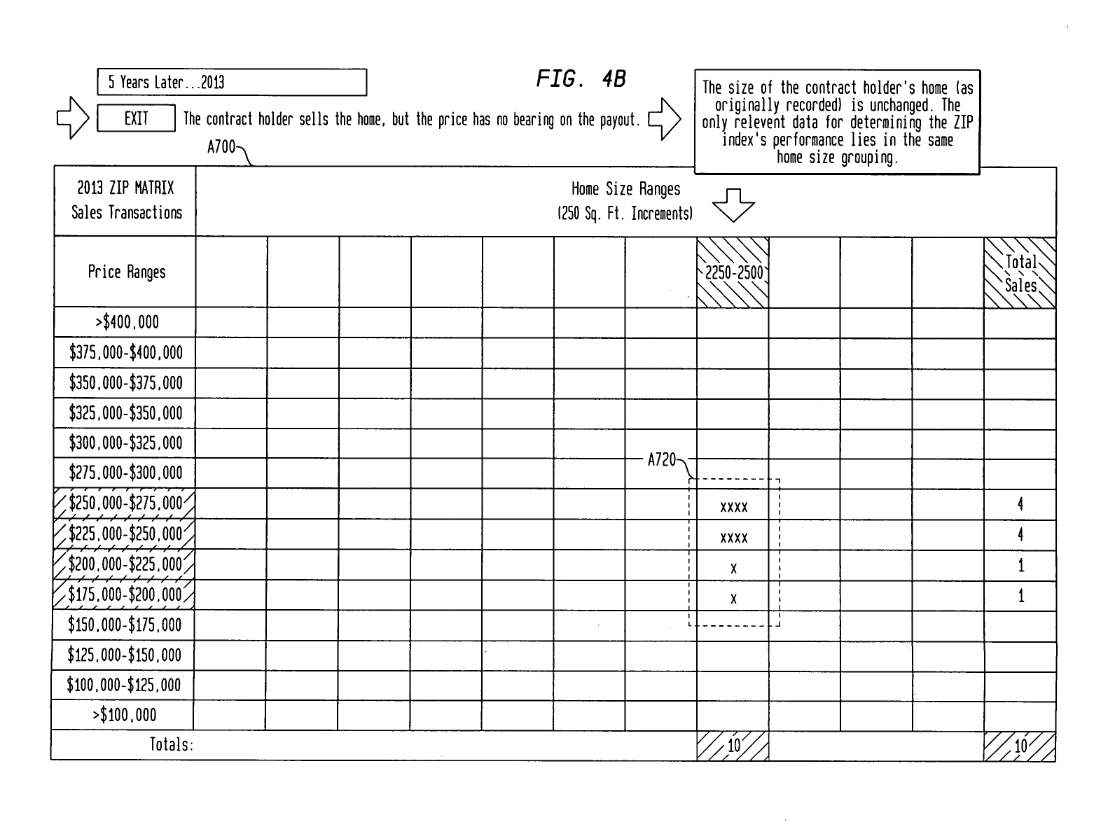

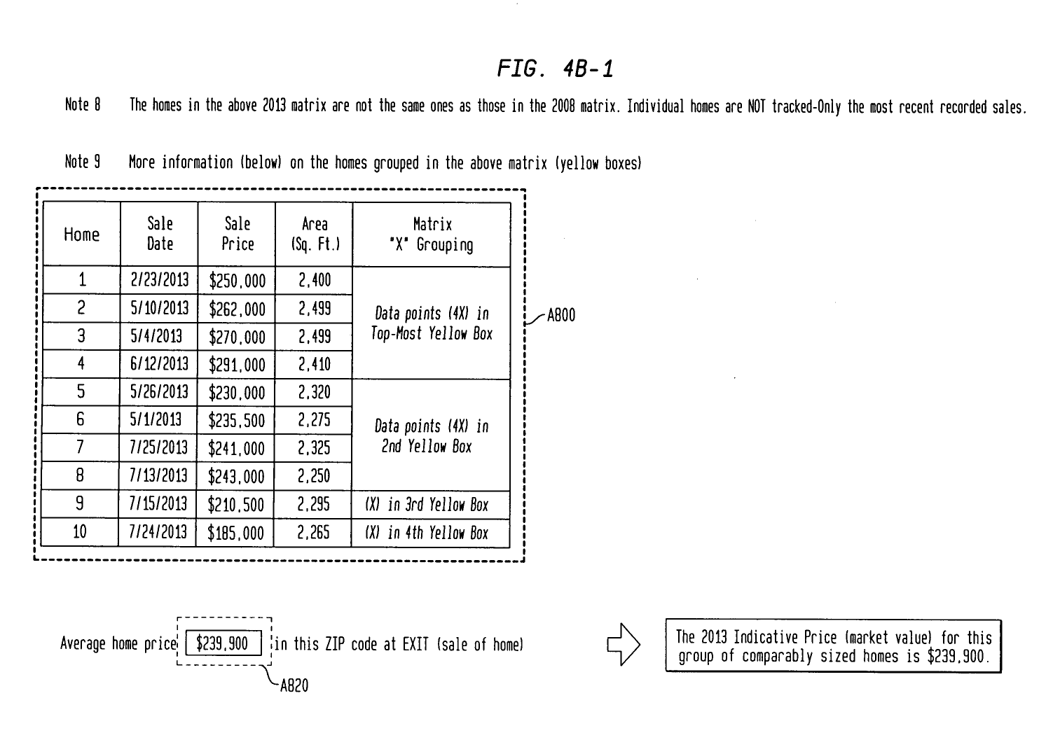

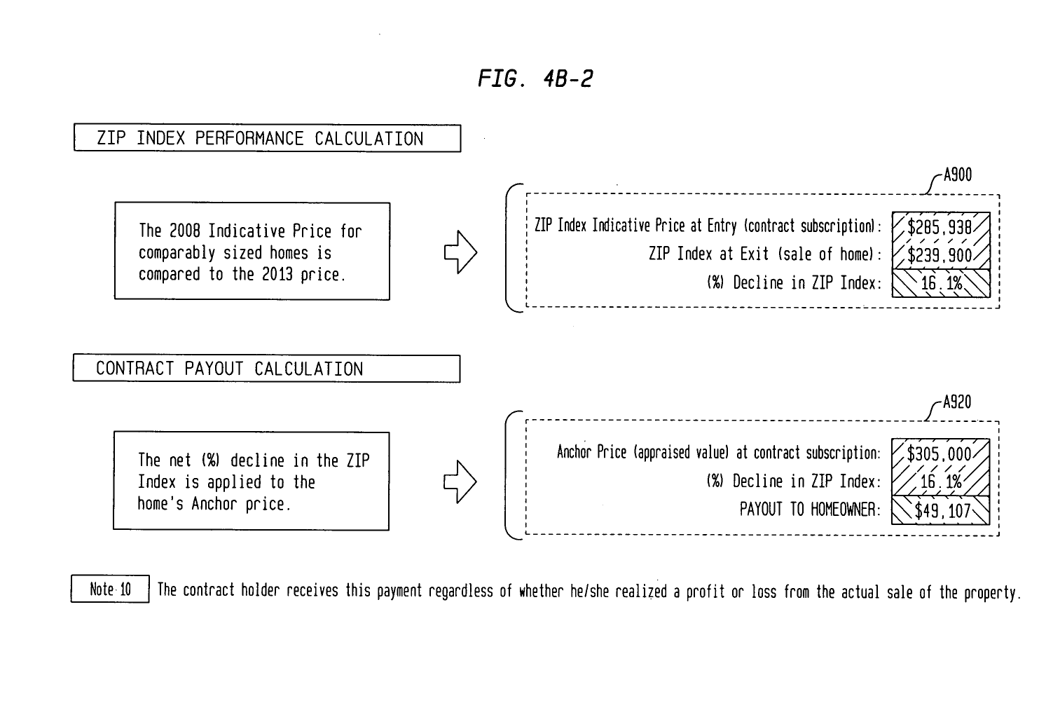

FIGS. 4A and 4B show a hypothetical example of home valuation in accordance with an aspect of the present invention. Although this example is discussed in relation to a home sales price, the present invention may be applied to, in general, other types of properties. As is shown in FIG. 4A, a home size of 2,350 square feet associated with a property for which a valuation is sought, e.g., a reference property, is provided at block A400. This home size is used to correlate the home with other comparatively sized homes from a predetermined area, for example, a geographic area or demographic area, and is the factor used to determine a unique value of the home. As is shown at block A500, the size of the home is used to identify and correlate the sales prices of similarly sized homes. In this example, these homes form the data set at block A520 and represent sales transactions that took place over a one year period in one zip code and for properties with sizes between 1000 and 3000 square feet. For the purposes of this example, block A520 comprises twelve data points. As discussed above, the sampling period, sampling area or sample size range may be varied so that the sample set is statistically sufficient.

For example, the number of transactions may be increased by adding transactions from other zip codes to expand the geographic area. Alternatively, the time period may be extended further back in time to capture other sales transactions. Although the size data may also be expanded, in the example of FIG. 4 including all the sales transactions shown would yield a total of 90 data points, which would preferably require expansion of either the area or time data.

Using the sample data set, the average sales price is then calculated at block A600. (The prices and sizes shown in block A600 is a breakout of the data points shown in block A530 of FIG. 4A.) In this example, a straight linear average is done, yielding an average sales price of $285,938 at block A620 (ENTRY value). This sales price represents a unique value of the home for which valuation is sought. In this regard, except for home size, the characteristics of the reference or target home have no bearing on its valuation. In particular, the number of bathrooms, fireplaces, bedrooms, whether it has a pool, etc. have no bearing on its value. In this way, the value calculated based on the present invention represents a new metric for assigning market values to homes and, in general, real estate, especially real estate with a structure thereon.

For example, as indicated at block A300, the value of the selected home is appraised at $305,000. That value, however, is not included in the valuation.

The sales price of the reference home may be included in a subsequent valuation and may be aggregated with sales data of other homes that are similar in size if the geographic or demographic area used includes the reference home for which valuation is sought. In this regard, with respect to new construction, e.g., homes which are on the market for the first time, no transaction data about those homes will be included in the valuation calculation. In fact, even for homes which have previously been sold, there is no need to include their prior sale transactions in the valuation transactions. For example, if a geographic area is chosen different than one where the reference home is located, then nothing about that home, other than its size being used in the correlation, is a factor in the valuation calculation. Thus, in accordance with an aspect of the present invention, a new valuation metric is provided.

As is shown in FIGS. 4A and 4B, other aspects of the invention include using the valuation as a hedge or to predict a minimum value associated with the home based on aggregate sales prices of homes of similar size over a relatively large geographic area. For example, if the valuation at block A620 is considered to be the current value of the home, it may be used as a hedge for the real estate market. That is, $285,938 may be considered as an entry point for a homeowner, who makes a purchase of the reference home. That valuation may then be used as a hedge against the value of the home in a future purchase. For example, as shown in blocks A700 and A800, if the value of the home using the valuation method of FIG. 1 at later time sale proves to be $239,900 (see block A820—EXIT value), then there would have been a 16.1% (block A900) decline in the value of the home. The 16.1% may then be used to determine a payout. For example, it may be applied to the appraised value to provide a payout of $49,107 (block A920), if the home is sold at that time.

As explained above, the new unique value is not tied to the sales price of the home, structure or property for which valuation is sought. Using the application of the method described in FIGS. 4A and 4B as an example, since payout is not dependent on the particular home, structure or property associated with the ENTRY and EXIT unique values, the payout may occur even if the home is sold at a profit.

In another aspect, the valuation may be used by, for example, a mortgage company or other securitization entity to assess the current value of its real estate portfolio. Current home valuation methodologies, in addition to associating sales prices with home characteristics such as the number of rooms, etc., factor in the mortgage on the home. One bill being considered by Congress to provide relief to the current crisis would require the mortgage lender to reduce the mortgage debt below the current perceived home value; that home value being calculated based on current methods. Mortgage companies are hesitant to do that, though, since the mortgage was originally tied to the value of the home. However, if that original value was incorrect (e.g., high), then the reduction in the debt may still capture the value of the home. In addition to alleviating the concerns of the mortgagee if the true value of the home was lower, it may also restore the confidence of the consumer to continue paying the mortgage. In accordance with the present invention, the value calculation method explained above may be used to calculate a new value metric associated with the lender's portfolio providing renewed comfort level to the lender and the homeowner.

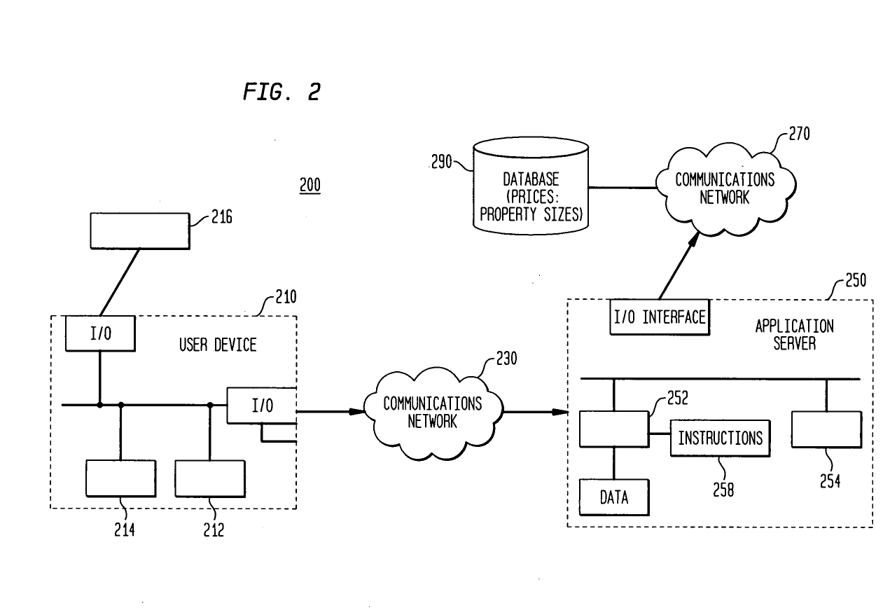

FIG. 2 shows a system 200 that may be used in practicing the method of the present invention described above. The system 200 includes a user device 210. The user device 210 may comprise a personal computer, laptop, or any other device that uses a memory 212 and processor 214 to perform instructions and that can use the communications network 230 to access the application server 250. In general, user device 210 may be regarded as a client computer.

In general, the user device's memory 212 stores information accessible by processor 214, including instructions that may be executed by the processor 214 and data that may be retrieved, manipulated or stored by the processor. The memory may be of any type capable of storing information accessible by the processor, such as a hard-drive, memory card, ROM, RAM, DVD, CD-ROM, write-capable, or read-only memories. The processor may comprise any number of well known processors, such as processors from Intel Corporation. Alternatively, the processor may be a dedicated controller such as an ASIC.

The communications network 230 may comprise the Internet with its collection of servers, routers, multiplexers, and other associated equipment. In general, however, the communications network generally includes any network that may be used to communicate data between different electronic devices such as user devices 210 or servers, such as application server 250. Such networks may include local and wide area networks.

The application server 250 includes a memory 252 and a processor 254. The memory 252 preferably includes instructions that are used by the processor 254 to execute the process or method described generally in FIG. 1. The application server 250 is linked through communications network 270 to a database 290. The communications network 270, like network 230, may comprise the Internet or any network that may be used to communicate data between different electronic devices, such as user device 210, or servers, such as application server 250. In fact, networks 230 and 270 may be the same network or share portions of a common network. The database 290 preferably stores sales price and property size data. Such data may be desirably stored based on geographic location, e.g., longitude and latitude information, zip code, etc., or demographic information such as income. In general, the database will include an association between sale price data and real estate size data as discussed above.

With respect to application server 250, memory 252 stores information accessible by processor 254, including instructions that may be executed by the processor 254 and data that may be retrieved, manipulated or stored by the processor. The memory may be of any type capable of storing information accessible by the processor, such as a hard-drive, memory card, ROM, RAM, DVD, CD-ROM, write-capable, or read-only memories.

As described above in relation to processor 214, the processor 254 may comprise any number of well known processors, such as processors from Intel Corporation. Alternatively, the processor may be a dedicated controller such as an ASIC.

The instructions may comprise any set of instructions to be executed directly (such as machine code) or indirectly (such as scripts) by the processor. In that regard, the terms “instructions,” “steps” and “programs” are used interchangeably herein. The instructions may be stored in object code form for direct processing by the processor, or in any other computer language including scripts or collections of independent source code modules that are interpreted on demand or compiled in advance. The functions, methods and routines of instructions in accordance with the present invention are as explained above and with the example below.

Data may be retrieved, stored or modified by processor 254 in accordance with the instructions 258. The data may be stored as a collection of data. For instance, although the invention is not limited by any particular data structure, the data may be stored in computer registers, in a relational database (e.g., database 290) as a table having a plurality of different fields and records, XML documents, or flat files. The data may also be formatted in any computer readable format such as, but not limited to, binary values, ASCII or EBCDIC (Extended Binary-Coded Decimal Interchange Code). Moreover, the data may comprise any information sufficient to identify the relevant information, such as descriptive text, proprietary codes, pointers, references to data stored in other memories (including other network locations) or information which is used by a function, e.g., such as correlation, to calculate the relevant data. For example, the data may be stored in tabular form using the data discussed above. For example, each data set preferably has associated with it an identification field which may be the name of a benchmark property, data indicative of sales price or size, and a file field which points to or contains a file representing other data.

Although the processor and memory are functionally illustrated in FIG. 2 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by the processor. Similarly, the processor may actually comprise a collection of processors which may or may not operate in parallel.

In one aspect, server 250 communicates with one or more user devices or client computers 210. Each user device or client computer may be configured similarly to the server 250, with a processor, memory and instructions. Each client computer may be a general purpose computer, intended for use by a person, having all the internal components normally found in a personal computer such as a central processing unit (CPU), a display 216, CD-ROM, DVD-drive, hard-drive, mouse, keyboard, speakers, microphone, modem and/or router (telephone, cable or otherwise) and all of the components used for connecting these elements to one another. Moreover, computers in accordance with the systems and methods described herein may comprise any device capable of processing instructions and transmitting data to and from humans and other computers, including network computers lacking local storage capability, PDA's with modems and Internet-capable wireless phones. In addition to input means such as a mouse, keyboard and microphone, and other means for inputting information from a human into a computer a touch-sensitive screen, voice recognition, etc. are also acceptable ways to input and control the user device.

The server 250 and client computer 210 are capable of direct and indirect communication, such as over a network. Although only one user device is depicted in FIG. 2, it should be appreciated that a typical system can include a large number of connected computers, with each different computer being at a different node of the network. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. As shown, server 250 may be a web server. Although certain advantages are obtained when information is transmitted or received as noted above, other aspects of the invention are not limited to any particular manner of transmission of information. For example, in some aspects, the information may be sent via a medium such as a disk, tape, or CD-ROM.

As explained above, the information may also be transmitted over a global or private network, or directly between two computer systems, such as via a dial-up modem. In other aspects, the information may be transmitted in a non-electronic format and manually entered into the system.

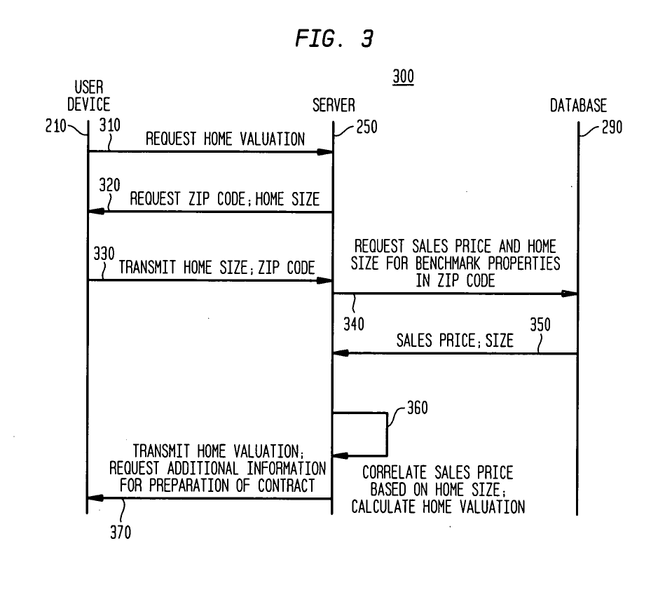

FIG. 3 shows a flow chart of method 300 in accordance with a further aspect of the present invention. As shown in FIG. 3, the method 300 may begin with a user at user device 210 requesting home valuation, step 310. This request is received at the server 250, which in turn may request that the user provide a home size and geographic or demographic parameter such as a zip code, and optionally an appraised value, step 320. Although a zip code for the target property is not required to be provided by a user, it may be conveniently used to determine which geographic area or zip code may be used in selecting properties for use in the valuation process. Likewise, the appraised value may be used for a separate calculation of payout value or used as a metric in another process.

The user may then respond by providing the request values to the server as shown at step 330. Using the home size, the server 250 accesses the database 290 to obtain sales prices for similarly sized homes, at step 340. As explained above, the server may request that the sales and size data be provided over a particular sampling period, within a particular size range and the geographic area. For example, as shown a user-provided zip code and size may be used to select the properties that will be provided by the database. The select properties may be in the provided zip code or may be used to select another zip code that more accurately reflects home value trends. In any event, the database responds at step 350 with sales prices and associated size data.

After receiving the sales prices and associated size data at step 350, the server 250 then selects the appropriate sales prices as discussed above by executing instructions associated with the method and calculates the home valuation or unique value. This calculation is shown at step 360.

The server 250 then transmits the home value to user device 210. Based on the home valuation calculation, the user may then decide to continue by requesting further services associated with the new home value.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

We claim:

1. A method for valuing real estate property, comprising:
associating a geographic area with a property having a predetermined size metric;
correlating one or more sales prices associated with a first set of benchmark properties, each benchmark property having a size metric within a range associated with the predetermined size metric of the property and selected based on the geographic area; and
determining a first value associated with the property based on the correlation.

2. The method according to claim 1, wherein the size metric of the properties are specified for the interior floor space of a structure on the property.

3. The method according to claim 2, further comprising determining a second value later in time associated with the property by correlating one or more sales prices associated with a second set of benchmark properties.

4. The method according to claim 3, further comprising determining a payout value based on the first value and the second value.

5. The method according to claim 4, wherein determining a payout value comprises computing a ratio associated with the difference between the first value and second value.

6. The method according to claim 2, wherein correlating comprises accessing a database having a plurality of postal codes, benchmark property values and size metrics, each benchmark property value being associated with a size metric, and processing the benchmark property values and size metrics to form a first group of property values within a predetermined statistical range.

7. The method according to claim 6, wherein processing further comprises accumulating 500 or more home sales prices associated with the benchmark properties based on the size metric to form the first group of property values.

8. The method according to claim 2, wherein determining a first value comprises computing an average sale price associated with each benchmark property having a size metric within a range associated with the predetermined size metric of the property.

9. The method according to claim 2, wherein correlating comprises correlating one or more sales prices associated with 100 or more benchmark properties.

10. The method according to claim 2, wherein correlating comprises associating the geographic area with a postal code.

11. The method according to claim 10, wherein correlating comprises associating the geographic area with a zip code.

12. The method according to claim 2, wherein the sales prices are between $100,000 and $800,000.

13. The method according to claim 2, wherein the structure is a residence.

14. The method according to claim 13, wherein the residence is a house.

15. The method according to claim 1, wherein the size metric of the properties are specified in acreage.

16. The method according to claim 1, wherein the size metric of the properties are specified in meters.

17. An apparatus for calculating a unique value associated with a residence, comprising:
a memory containing executable instructions; and
a processor programmed using the instructions to:
request a unique value associated with a specified residence,
transmit a specified size value associated with the specified residence,
transmit a specified geographic area associated with the specified residence, and
receive the unique value, the unique value correlating to an average property price associated with one or more sales prices of benchmark residences, each benchmark residence having a size metric within a range associated with the predetermined specified residence size metric and selected based on a geographic area associated with the specified residence.

18. The apparatus of claim 17, wherein the residence is a house.

19. The apparatus according the claim 17, wherein the residence size metric and benchmark residence size metrics are measured as interior floor space of the residences.

20. The apparatus according to claim 17, wherein the geographic area comprises a postal code.

21. The apparatus of claim 20, wherein the geographic area comprises a zip code.

22. The apparatus according to claim 7, wherein the geographic area comprises a neighborhood or a town.

23. The apparatus according to claim 17, further comprising the processor transmitting an appraised value associated with the residence.

24. An apparatus for calculating a unique value associated with a residence, comprising:
a memory containing executable instructions; and
a processor programmed using the instructions to:
receive a request for a unique value associated with a residence,
request a residence size value associated with the residence, and
transmit the unique value, the unique value correlating to an average residence price associated with one or more sales prices associated with benchmark properties, each benchmark property having a residence size metric within a range associated with the predetermined residence size metric and selected based on a geographic area associated with the residence.

25. The apparatus according to claim 4, wherein the residence size metric and benchmark property residence size metrics are specified as interior floor space of the residences.

26. The apparatus of claim 25 wherein the residence is a house.

27. The apparatus of claim 25, wherein the geographic area is selected from a group consisting of a postal code, zip code, town, city, state or province.

28. A system for determining home values, comprising:
a server;
a database accessible by the server and having sales price data and property size data associated with a plurality of benchmark properties within a predetermined geographic area, each benchmark property being associated with at least one benchmark data set having a sales price and a property size; and
a client device having a memory containing executable instructions and a processor programmed using the instructions to:
access the server to request a first property value for a specified property;
respond to a request from the server for a property size value associated with the specified property and a geographic area metric associated with the specified property, and
receive the first property value associated with the specified property from the server, the first property value comprising an average sales price for all benchmarked marked properties having a property size within a predetermined size range and within the specified geographic area metric.

29. An index for real estate valuation, comprising a plurality of recorded real estate sale prices within a geographic area metric and a correlation of the recorded real estate prices with a predetermined size metric for the real estate within the geographic area metric, whereby the correlation provides a real estate valuation.

30. A market value mechanism for compensating home buyers for market devaluation, comprising:
compiling an index of recorded home sales prices within a predetermined geographic area metric;
correlating the recorded home sales prices with the size of a home based on a predetermined property size metric to generate a market value index; and
determining a first market value for a reference home having a predetermined size based on the sales price of a first set of recorded homes in the index within a size range of the predetermined sized.

31. The market value mechanism of claim 30, further comprising determining a second market value for the reference home based on the sales prices of a second set of recorded homes in the index within the size range of the predetermined property size metric.
